(19) United States
(12) Patent Application Publication
(10) Pub. No.: US 2003/0224167 A1
(43) Pub. Date: Dec. 4, 2003

(54) Hybrid gem System

(76) Inventor: Less P. Wright, Kirkland, WA (US)

Correspondence Address: Michael S. Neustel, Suite No. 4, 2534 South University Drive, Fargo, ND, 58103, US

(21) Appl. No.: 10/158,489

(22) Filed: May 28, 2002

(51) Int. Cl. B32B 9/00

(52) U.S. Cl. 428/408; 428/336

(57) ABSTRACT

A hybrid gem system for providing a protective coating and enhanced optical qualities to a gem media. The hybrid gem system includes coating an first portion and a second portion of a gem media with a diamond like carbon (DLC) coating. The gem media may be comprised of any gem structure including synthetic or natural. The DLC coating enhances the wear resistance, color and optical characteristics of the underlying gem media.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to gem and more specifically it relates to a hybrid gem system for providing a protective coating and enhanced optical qualities to a gem media.

2. Description of the Related Art

Gems have been in use for years. Gems may be comprised of natural or man-made media such as but not limited to rubies, sapphires, emeralds, diamonds or other stones. Conventional gems are typically cut to a desired shape and are often times placed within a metal settings.

The main problem with conventional gems is that they can become scratched and worn overtime thereby reducing their attractiveness. Another problem with conventional gems is that they often times do not have the desired optical beauty. A further problem with conventional gems is that they often times do not have the desired color grade.

Examples of patented devices which may be related to the present invention include U.S. Pat. No. 6,277,480 to Veerasamy et al.; U.S. Pat. No. 5,795,648 to Goel et al.; U.S. Pat. No. 6,312,808 to Veerasamy et al.; U.S. Pat. No. 5,635,245 to Kimock et al.; U.S. Pat. No. 6,338,901 to Veerasamy; U.S. Pat. No. 6,335,086 to Veerasamy; U.S. Pat. No. 5,190,807 to Kimock et al.; and U.S. Pat. No. 5,879,775 to Walter et al.

While these devices may be suitable for the particular purpose to which they address, they are not as suitable for providing a protective coating and enhanced optical qualities to a gem media. Conventional gems are susceptible to wearing and often times do not have the desired optical characteristics.

In these respects, the hybrid gem system according to the present invention substantially departs from the conventional concepts and designs of the prior art, and in so doing provides an apparatus primarily developed for the purpose of providing a protective coating and enhanced optical qualities to a gem media.

### BRIEF SUMMARY OF THE INVENTION

In view of the foregoing disadvantages inherent in the known types of gem structures now present in the prior art, the present invention provides a new hybrid gem system construction wherein the same can be utilized for providing a protective coating and enhanced optical qualities to a gem media.

The general purpose of the present invention, which will be described subsequently in greater detail, is to provide a new hybrid gem system that has many of the advantages of the gems mentioned heretofore and many novel features that result in a new hybrid gem system which is not anticipated, rendered obvious, suggested, or even implied by any of the prior art gems, either alone or in any combination thereof.

To attain this, the present invention generally comprises coating an first portion and a second portion of a gem media with a diamond like carbon (DLC) coating. The gem media may be comprised of any gem structure including synthetic or natural. The DLC coating enhances the wear resistance, color and optical characteristics of the underlying gem media.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a hybrid gem system that will overcome the shortcomings of the prior art devices.

A second object is to provide a hybrid gem system for providing a protective coating and enhanced optical qualities to a gem media.

Another object is to provide a hybrid gem system that increases the wear resistance of a gem media.

An additional object is to provide a hybrid gem system that increases the optical characteristics of a gem media including but not limited to light dispersion and refraction.

A further object is to provide a hybrid gem system that increases the color grade of a transparent gem media such as but not limited to diamonds.

Another object is to provide a hybrid gem system that may be utilized upon various types of gem media including natural or man-made.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a flowchart of the inventive process.

FIG. 2 is a side view of a non-coated gem media.

FIG. 3 is a side view of the gem media with an first portion coated with an first layer.

FIG. 4 is a side view of a gem medial with an first portion and second portion coated.

FIG. 5 is a side cutaway view of the gem media of FIG. 4.

### DETAILED DESCRIPTION OF THE INVENTION

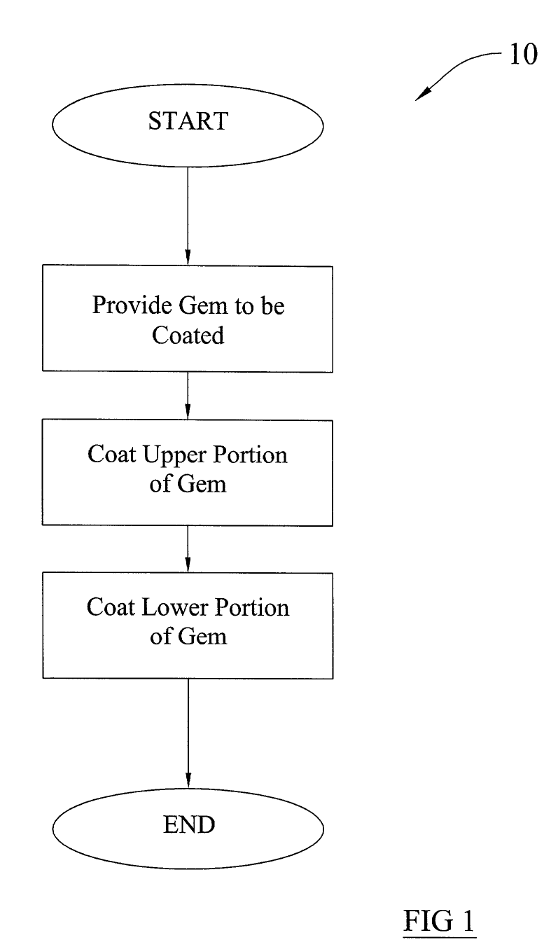

Turning now descriptively to the drawings, in which similar reference characters denote similar elements throughout the several views, FIGS. 1, 3, 4 and 5 illustrate a hybrid gem system 10, which comprises coating an first portion 24 and a second portion 22 of a gem media 20 with a diamond like carbon (DLC) coating. The gem media 20 may be comprised of any gem structure including synthetic or natural. The DLC coating enhances the wear resistance, color and optical characteristics of the underlying gem media 20.

FIG. 1 illustrates the desired process for coating a gem media 20 with DLC. DLC provides a hard, transparent and wear resistant coating. U.S. Pat. No. 5,879,775 discloses an acceptable coating process and structure utilizing DLC and is hereby incorporated by reference for describing how to utilize DLC. There are various other DLC coating procedures and compositions that may be utilized with the present invention to achieve similar results.

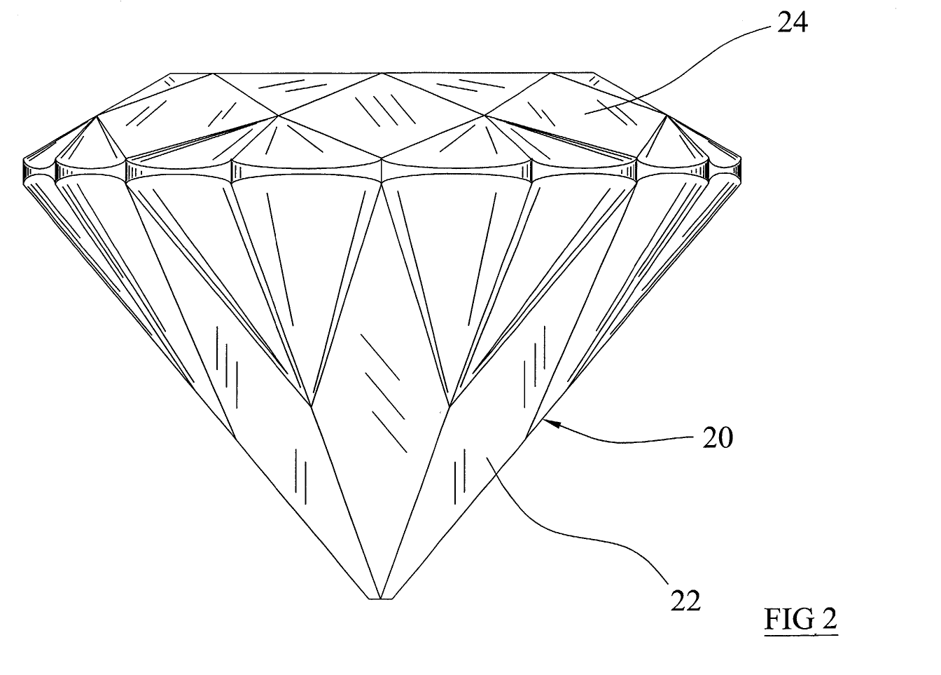

FIG. 2 illustrates an exemplary gem media 20 having a solid exterior surface. It can be appreciated that the gem media 20 may be pre-cut to have various sizes, shapes and structure which are commonly utilized within the jewelry industry other than illustrated in the attached drawings. The gem media 20 may also be comprised of various gemstones including synthetic or natural such as but not limited to diamonds, rubies, sapphires, emeralds and other stones.

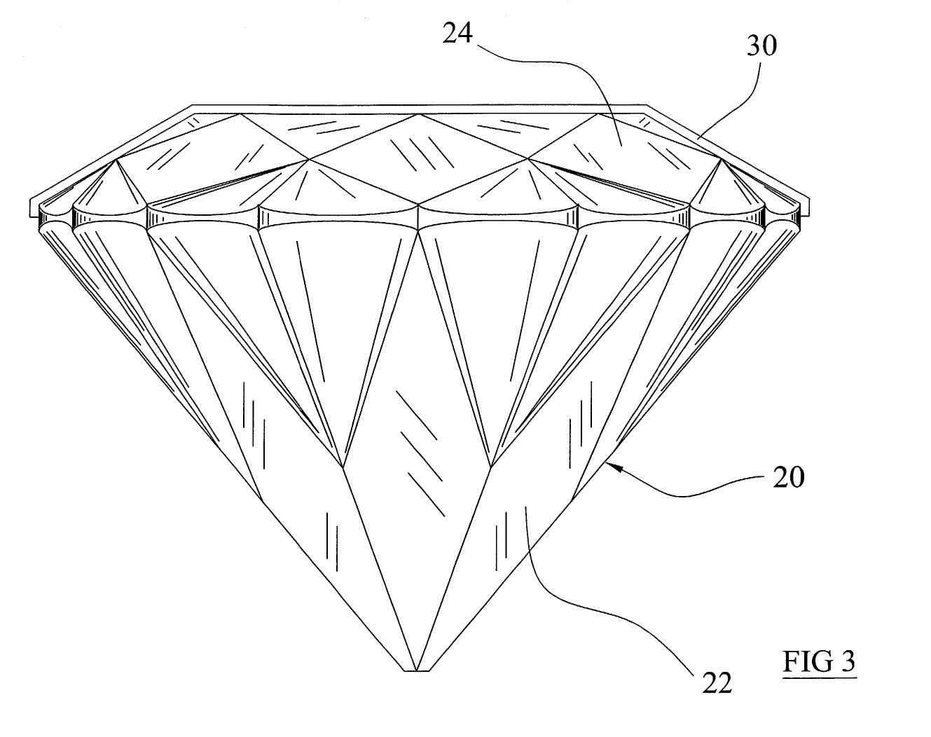

Utilizing a conventional DLC application process, the first portion 24 of the gem media 20 is preferably coated with a first layer 30 as shown in FIG. 3 of the drawings. The first portion 24 may represent the broad upper portion of the gem media 20 (if applicable) or the lower tapering portion of the gem media 20 (if applicable). The first layer 30 is comprised of DLC or similar transparent coating. The thickness of the first layer 30 may vary as desired depending upon the gem media 20 and application the gem is to be utilized within.

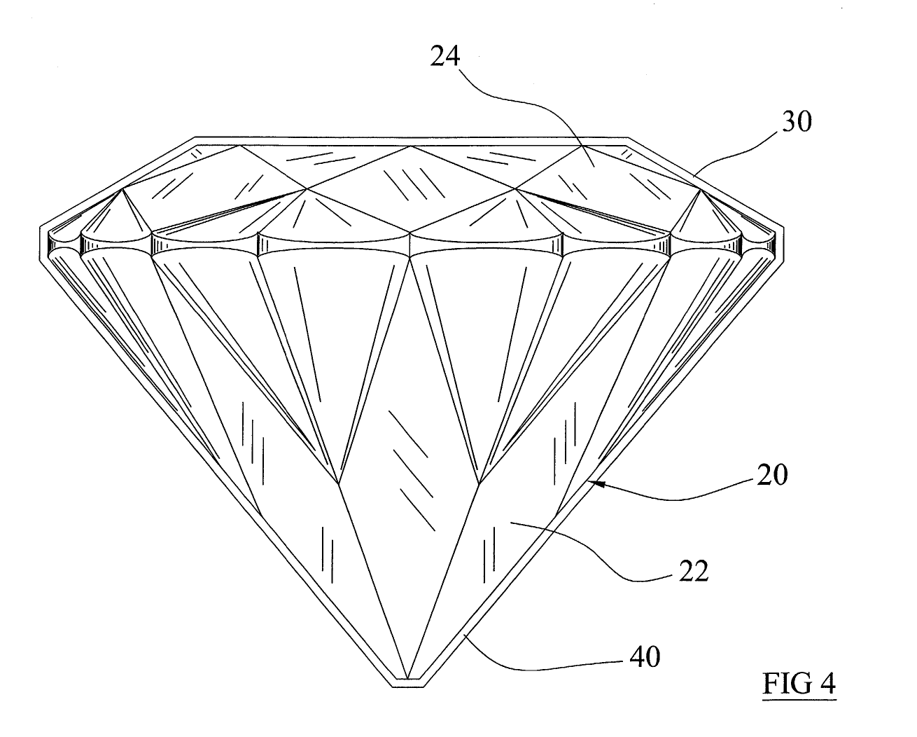

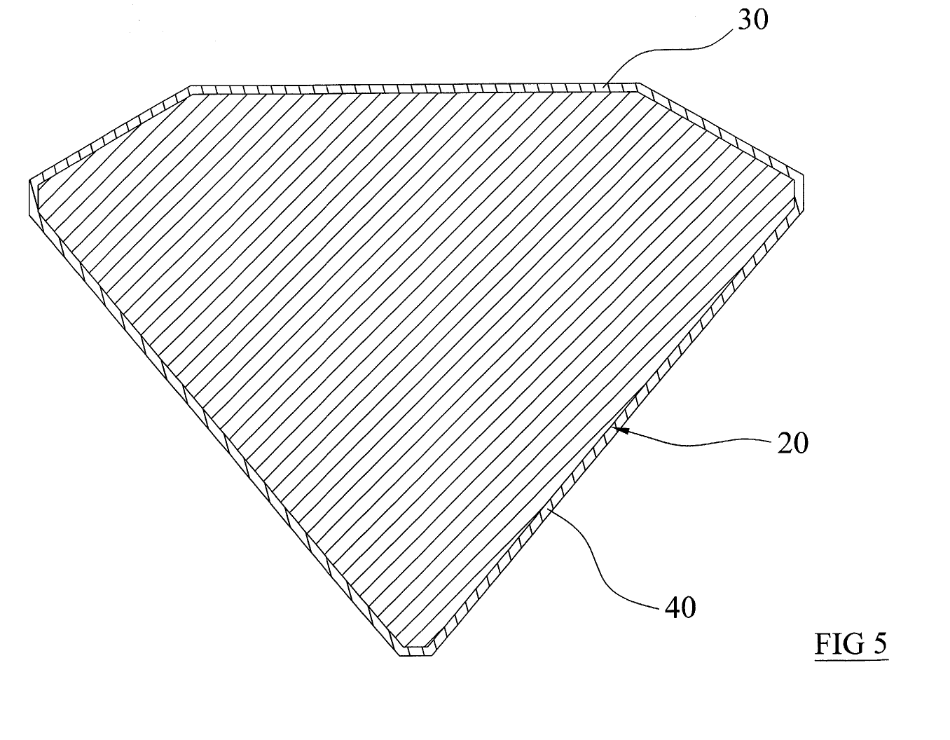

After the first layer 30 has been applied to the gem media 20 and hardened, the second portion 22 of the gem media 20 is then coated with a second layer 40 thereby providing the DLC coating about the entire exterior surface of the gem media 201 as shown in FIGS. 4 and 5 of the drawings. The second layer 40, similar to the first layer 30, is comprised of DLC or similar transparent coating.

The thickness of the second layer 40 may vary as desired depending upon the gem media 20 and application the gem is to be utilized within. The second layer 40 may be thinner or thicker. In addition, the second layer 40 and the first layer 30 may each have varying thickness throughout as desired. The inventor has found that a uniform thickness of approximately 300 angstroms is optimal for each layer 30, 40.

Alternatively, the first layer 30 and the second layer 40 may be applied simultaneously upon the gem media 20. In another alternative embodiment, only a portion of the gem media 20 is covered with the DLC coating.

The DLC coating upon the gem media 20 preferably covers the entire exterior surface of the gem media 20 for providing enhanced optical characteristics such as but not limited to increased light dispersion, light refraction, and color grade. DLC coatings have a high refractive index which increases the overall refraction of the gem media 20. The inventor has also discovered during testing that by coating the gem media 20 with a DLC coating that the gem media 20 is diluted by the DLC optics thereby improving the overall apparent color grade of the gem media 20. In addition, the DLC coating about the gem media 20 provides increased wear resistance to scratching and other damaging events. The inventor has found that by coating the gem media 20 with the DLC coating that the hardness of the gem media 20 is increased by at least 0.50 Mohs. The inventor has also found that the best results occur when the gem media 20 is comprised of a transparent gemstone such as but not limited diamond.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A hybrid gem, comprising:
a gem media having an exterior surface; and
a DLC coating on said gem media.

2. The hybrid gem of claim 1, wherein said DLC coating has a uniform thickness about said gem media.

3. The hybrid gem of claim 2, wherein said uniform thickness is approximately 300 angstroms.

4. The hybrid gem of claim 1, wherein said DLC coating has a non-uniform thickness about said gem media.

5. The hybrid gem of claim 1, wherein said gem media is comprised of a natural gemstone.

6. The hybrid gem of claim 1, wherein said gem media is comprised of a synthetic gemstone.

7. The hybrid gem of claim 1, wherein said DLC coating covers 100% of said exterior surface of said gem media.

8. The hybrid gem of claim 1, wherein said DLC coating covers less than 90% of said exterior surface of said gem media.

9. The hybrid gem of claim 1, wherein said gem media has a first portion and a second portion, and wherein said DLC coating has a first layer on said first portion and a second layer on said second portion.

10. The hybrid gem of claim 9, wherein said second layer is applied to said gem media after said first layer.

11. A method of manufacturing a hybrid gem, said method comprising the steps of:
(a) providing a gem media comprised of a gemstone material; and
(b) coating an entire exterior of said gem media with a DLC coating.

12. The method of manufacturing a hybrid gem of claim 11, wherein said gem media is comprised of a natural gemstone.

13. The method of manufacturing a hybrid gem of claim 11, wherein said gem media is comprised of a synthetic gemstone.

14. The method of manufacturing a hybrid gem of claim 11, wherein said gem media has a first portion and a second portion, and wherein said DLC coating has a first layer on said first portion and a second layer on said second portion.

15. The method of manufacturing a hybrid gem of claim 14, wherein said second layer is applied to said gem media after said first layer.

16. The method of manufacturing a hybrid gem of claim 11, wherein said DLC coating has a thickness of approximately 300 angstroms.

17. A method of manufacturing a hybrid gem, said method comprising the steps of:
(a) providing a gem media comprised of a gemstone material having a first portion and a second portion;
(b) coating said first portion with a first layer of DLC coating; and
(c) coating said second portion with a second layer of DLC coating.

18. The method of manufacturing a hybrid gem of claim 17, wherein said gem media is comprised of a natural gemstone.

19. The method of manufacturing a hybrid gem of claim 17, wherein said gem media is comprised of a synthetic gemstone.

20. The method of manufacturing a hybrid gem of claim 17, wherein said first layer and said second layer each have a thickness of approximately 300 angstroms.
